(19) United States
(12) Patent Application Publication
(10) Pub. No.: US 2024/0275236 A1
(43) Pub. Date: Aug. 15, 2024

(54) NON- BACK DRIVABLE LINEAR ACTUATOR SYSTEM AND THE METHOD EMPLOYED THEREOF

(71) Applicants: JOHN MICHAEL HEIBERGER, Grand Blanc, MI (US); STEPHEN J. BRINCK, Center Line, MI (US)

(72) Inventors: JOHN MICHAEL HEIBERGER, Grand Blanc, MI (US); STEPHEN J. BRINCK, Center Line, MI (US)

(21) Appl. No.: 18/108,732

(22) Filed: Feb. 13, 2023

(51) Int. Cl. H02K 7/06

(52) U.S. Cl. CPC H02K 7/06

(57) ABSTRACT

A non-back drivable linear actuator system, comprising first housing assembly and second housing assembly, first housing assembly includes first proximal portion, first middle portion and first distal portion, first proximal portion of first housing assembly accommodate nuts configured with inner flutes and first hall sensor; first middle portion of first housing assembly accommodate tube, low lead screw and anti-rattle component, low lead screw and anti-rattle component located inside tube; first distal portion of first housing assembly accommodate second hall sensor; first ball socket connected to first proximal portion of first housing assembly; second ball socket connected to first distal portion of first housing assembly; second housing assembly includes second proximal portion, second middle portion and second distal portion, second proximal portion of second housing assembly accommodates gears; second middle portion of second housing assembly accommodates gearbox; and second distal portion of second housing assembly accommodates motor.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to a linear actuator. More particularly, the present disclosure relates to a non-back drivable linear actuator system operable for moving a vehicle closure between an open position and a closed position.

### BACKGROUND

A linear actuator is a device used to induce linear movement, typically reciprocating linear motion, of a workpiece along a desired path of action. A typical linear actuator includes an electric motor having a rotatable output shaft. The output shaft of the electric motor is connected through a gear train to a nut and lead screw mechanism. The rotation of the output shaft of the electric motor causes the corresponding rotation of the lead screw. The nut has an opening formed there through having an internal thread. The lead screw extends through the opening and has an external thread formed, which cooperates with the internal thread formed on the nut. The nut mounted on the lead screw restrains from rotating with the lead screw when the lead screw rotates. As a result, rotation of the lead screw causes linear movement of the nut axially along the lead screw. The direction of such axial movement of the nut depends upon the direction of rotation of the lead screw.

Linear actuators are widely used in a variety of applications ranging from small to heavy loads. The existing linear actuator structures have been formed from relatively large and heavy metallic components. Consequently, the linear actuator systems currently in use are relatively heavy and expensive.

However, the conventional systems require a greater operational force to operate the vehicle closure when it is exposed to a very cold weather condition or being installed insufficiently (not well-built condition), and even the manual operation to move the vehicle closure to a preset position, from where the powered operation assumes, is difficult. The vehicle closure operation will not get started if such a condition occurs. This is inconvenient for the user of the vehicle who needs to use such a system for some reasons such as convenience. Further, the conventional systems are back-drivable by external forces or when driven on bumpy terrain. Hence, there is a need to develop a non-back drivable linear actuator system for moving a vehicle closure between a fully open position and a fully closed position.

In the light of the aforementioned discussion, there exists a need for a certain system with novel methodologies that would overcome the above-mentioned challenges.

### SUMMARY

The following invention presents a simplified summary of the disclosure in order to provide a basic understanding to the reader. This summary is not an extensive overview of the disclosure, and it does not identify key/critical elements of the invention or delineate the scope of the invention. Its sole purpose is to present some concepts disclosed herein in a simplified form as a prelude to the more detailed description that is presented later.

An objective of the present disclosure is directed towards a non-back drivable linear actuator system that is operable for moving a vehicle closure between a fully open position and a fully closed position.

Another objective of the present disclosure is directed towards the system that is designed to be non-back drivable so that the vehicle closure does not drift open/closed when a vehicle is driven on bumpy terrain.

Another objective of the present disclosure is directed towards the system that provides an improved linear actuator structure that is relatively lightweight and inexpensive to produce.

Another objective of the present disclosure is directed towards the system that includes a first hall sensor positioned at a first proximal portion of the linear actuator to detect the fully closed position of the vehicle closure.

Another objective of the present disclosure is directed towards the system that includes a second hall sensor positioned at a first distal portion of the linear actuator to detect the fully open position of the vehicle closure.

Another objective of the present disclosure is directed towards the first hall sensor and/or the second hall sensor is potted for water protection.

Another objective of the present disclosure is directed towards the system that includes a screw designed with low lead, so the linear actuator is not back-drivable by external forces.

Another objective of the present disclosure is directed towards the system that includes a plastic designed as an anti-rattle component to eliminate rattle as the low lead screw moves inside a tube.

Another objective of the present disclosure is directed towards the system that includes a first housing assembly and inner flutes to allow translation movement of nuts and the tube.

Another objective of the present disclosure is directed towards the system that uses hall sensors and ring magnets packaged at the motor shaft, and this arrangement is designed to be used with a body control module.

According to an exemplary aspect of the present disclosure, the non-back drivable linear actuator system includes a first housing assembly and a second housing assembly, the first housing assembly includes a first proximal portion, a first middle portion and a first distal portion.

According to another exemplary aspect of the present disclosure, the first proximal portion of the first housing assembly accommodates one or more nuts configured with one or more inner flutes and a first hall sensor.

According to another exemplary aspect of the present disclosure, the first middle portion of the first housing assembly accommodates a tube, a low lead screw and an anti-rattle component, the low lead screw and the anti-rattle component located inside the tube; the first distal portion of the first housing assembly accommodates a second hall sensor.

According to another exemplary aspect of the present disclosure, a first ball socket connected to the first proximal portion of the first housing assembly and a second ball socket connected to the first distal portion of the first housing assembly.

According to another exemplary aspect of the present disclosure, the second housing assembly includes a second proximal portion, a second middle portion and a second distal portion, the second proximal portion of the second housing assembly accommodates gears; the second middle portion of the second housing assembly accommodates a gearbox; and the second distal portion of the second housing assembly accommodates a motor.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1A and FIG. 1B are diagrams depicting a non-back drivable linear actuator system and a cross-sectional view of the non-back drivable linear actuator, in accordance with one or more exemplary embodiments.

FIG. 2A is a diagram depicting a first housing assembly of the linear actuator system, in accordance with one or more exemplary embodiments.

FIG. 2B is another diagram depicting nuts and tube assembly, in accordance with one or more exemplary embodiments.

FIG. 3A is another diagram depicting an internal relay unit and the hall sensor limit switch, in accordance with one or more exemplary embodiments.

FIG. 3B is another diagram depicting an external relay unit and the hall sensor limit switch, in accordance with one or more exemplary embodiments.

FIG. 4 is a flow diagram depicting a method for activating the second hall sensor when the vehicle closure opens to the fully open position, in accordance with one or more exemplary embodiments.

FIG. 5 is a flow diagram depicting a method for activating the first hall sensor when the vehicle closure closes to the fully closed position, in accordance with one or more exemplary embodiments.

FIG. 6 is a flow diagram depicting a method for opening and closing the tube using the non-back drivable linear actuator, in accordance with one or more exemplary embodiments.

Furthermore, the objects and advantages of this invention will become apparent from the following description and the accompanying annexed drawings.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

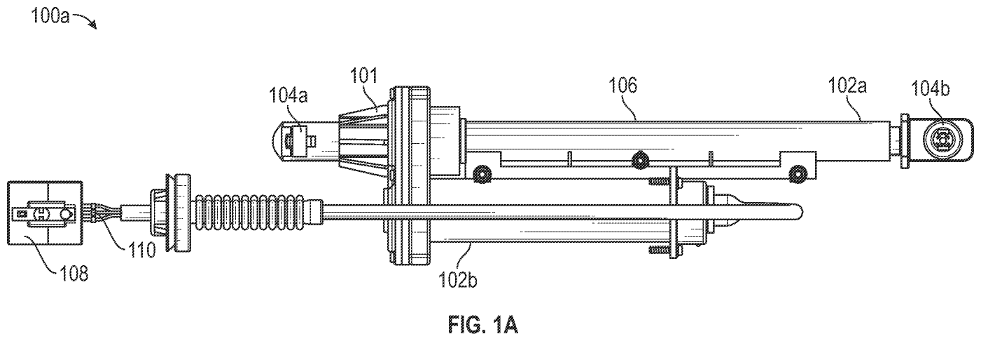

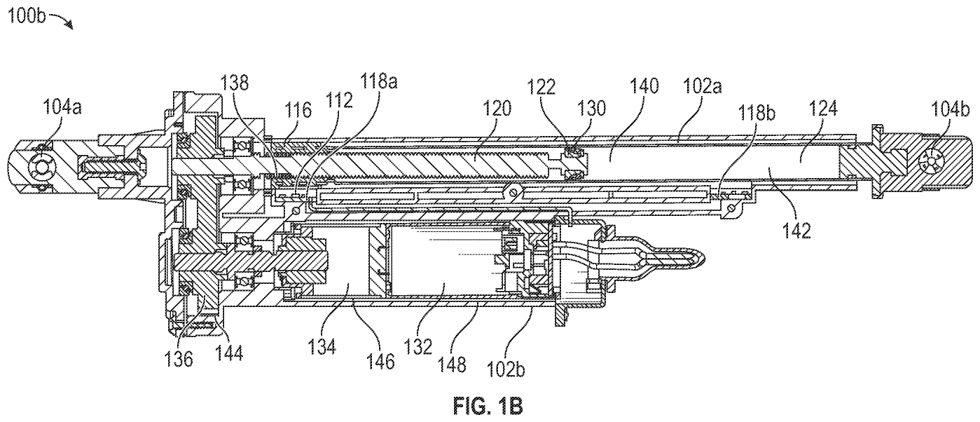

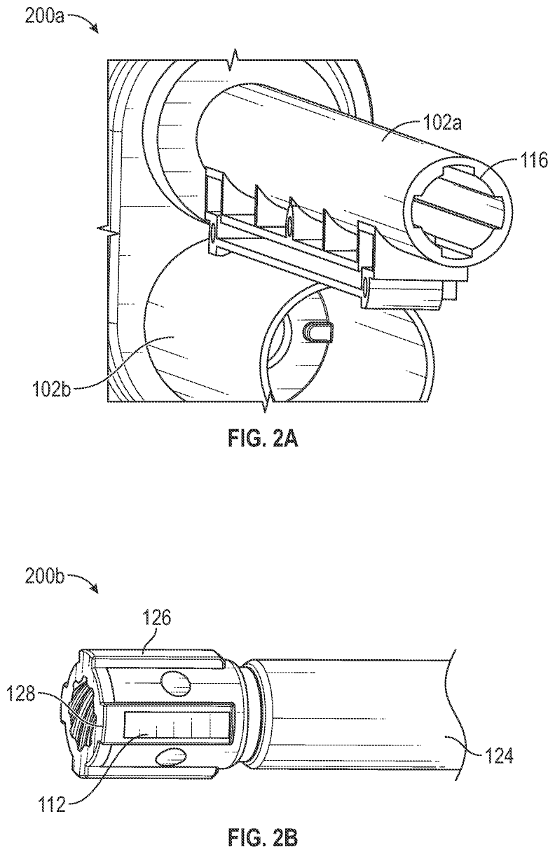

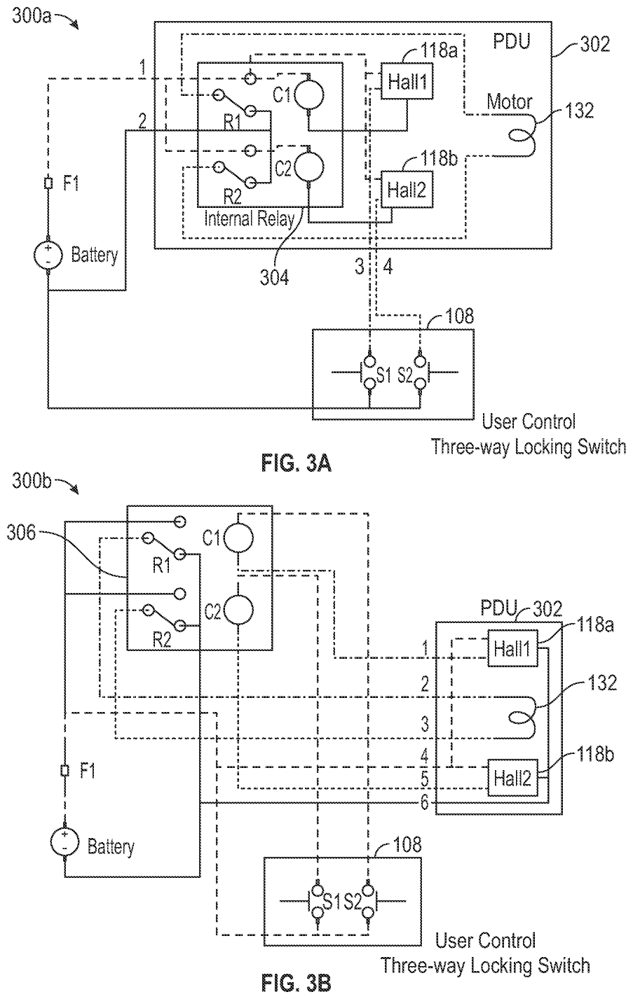

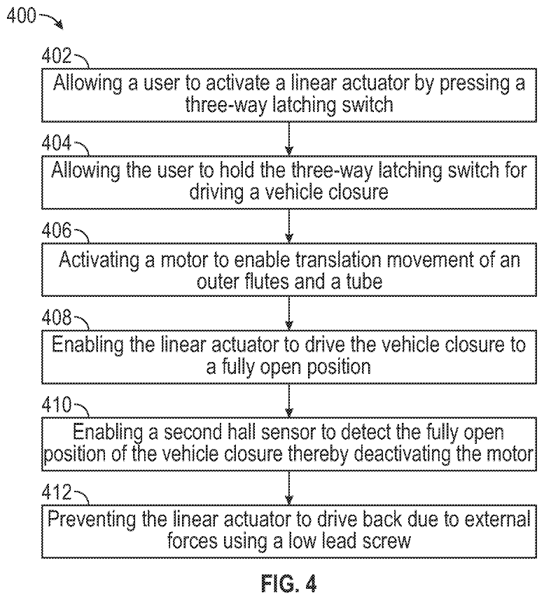

Referring to FIG. 1A and FIG. 1B are diagrams 100a and 100b depicting a non-back drivable linear actuator system and a cross-sectional view of the non-back drivable linear actuator system, in accordance with one or more exemplary embodiments. The diagram 100a and 100b depict the non-back drivable linear actuator system 101. The non-back drivable linear actuator system 101 depicts a first housing assembly 102a, a second housing assembly 102b, a quick connect ball sockets 104a and 104b, a split axis design 106, a three-way latching switch 108, an electronic hardware 110, and relay components(an internal relay and an external relay as shown in FIG. 3A and FIG. 3B). The diagram 100b depicts the first housing assembly 102a, the second housing assembly 102b. The first housing assembly 102a may be configured to accommodate a magnet 112, an inner flutes 116 (as shown in FIG. 2A), a first hall sensor 118a, a second hall sensor 118b, a low lead screw 120, a plastic 122, and a tube 124. The tube 124 includes outer flutes 126 (as shown in FIG. 2B), nuts 128 (as shown in FIG. 2B), and an anti-rattle component 130. The second housing assembly 102b may be configured to accommodate a motor 132, a gearbox 134, and gears 136. The first housing assembly 102a includes a first proximal portion 138, a first middle portion 140, and a first distal portion 142. The second housing assembly 102b includes a second proximal portion 144, a second middle portion 146, and a second distal portion 148.

The non-back drivable linear actuator system 101 is designed to be used as a “dumb” system, i.e., there is no electronic control unit to keep track of an actuator position and to control the speed of the linear actuator. The relay components include an internal relay, and an external relay may be housed inside the linear actuator or may be housed in the vehicle near the user-controlled switch (the three-way latching switch 108). The system 101 is designed to be non-back drivable, so the vehicle closure does not drift open/closed when a vehicle is driven on bumpy terrain. The system 101 may be designed in the split axis design 106 for hard-to-package conditions.

The first hall sensor 118a may be positioned at the first proximal portion 138 of the first housing assembly 102a to detect the fully closed position of the tube. The second hall sensor 118b may be positioned at the first distal portion 142 of the first housing assembly 102a to detect the fully open position of the tube. The first hall sensor 118a may be configured to detect the fully closed position of the tube 124 when the low lead screw 120 drives the tube 124 from the first distal portion 142 to the first proximal portion 138 of the first housing assembly 102a. The second hall sensor 118b may be configured to detect the fully open position of the tube 124 when the low lead screw 120 drives the tube 124 from the first proximal portion 138 to the first distal portion 142 of the first housing assembly 102a. The first hall sensor 118a and the second hall sensor 118b may be potted for water protection.

The motor 132 may be operatively connected to the gearbox 134 and the gears 136 and is operable to drive the vehicle closure open and closed position upon receiving a command from the first hall sensor 118a and the second hall sensor 118b. The magnet 112 may be attached to the outer flutes. The motor 132 may be configured to rotate the low lead screw 120 in the forward direction to drive the tube 124 from the first proximal portion 138 to the first distal portion 142 of the first housing assembly 102a to open the vehicle closure. The motor 132 may be configured to rotate the low lead screw 120 in a backward direction to drive the tube 124 from the first distal portion 142 to the first proximal portion 138 of the first housing assembly 102a to close the vehicle closure. The first middle portion 140 of the first housing assembly 102a accommodates the tube 124. The low lead screw 120 may be configured to drive the tube 124 from at least one of: the first proximal portion 138 to the first distal portion 142 of the first housing assembly 102a; or from the first distal portion 142 to the first proximal portion 138 of the first housing assembly 102a when the user holds the three-way latching switch 108.

The three-way latching switch 108 may be configured to activate the motor 132 to enable translation movement of the inner flutes 116 and the tube 124 upon pressing the three-way latching switch 108 by the user. The low lead screw 120 may be configured to perform translation movement of the inner flutes 116 and the tube 124. The inner flutes 116 may be configured to allow translation movement of the nuts 128. The nuts 128 are over-molded onto the tube 124. The tube 124 includes the outer flutes 126 may be configured to allow translation movement of the nuts 128. The outer flutes 126 include the magnet 112 may be fixed to the nuts 128.

In accordance with one or more exemplary embodiments of the present disclosure, the linear actuator 102 may be activated by a user when the user presses the three-way latching switch 108 to open the vehicle closure. Further, if the user holds the three-way latching switch 108 thereby, the linear actuator 102 may be configured to drive the vehicle closure until the vehicle closure opens to the fully open position. The second hall sensor 118b may be positioned at the first distal portion 142 of the linear actuator 102 and is configured to detect the fully open position of the vehicle closure thereby the second hall sensor 118b functions to deactivate the motor 132 when the vehicle closure opens to the fully open position. The second hall sensor 118b may be positioned at a fully open position of the vehicle closure. The first hall sensor 118a and/or the second hall sensor 118b may be potted for water protection. The anti-rattle component 130 may be designed with a plastic 122 to eliminate rattle as the low lead screw 120 moves inside the tube 124. The anti-rattle component 130 may be designed with spring features to eliminate rattle as the low lead screw 120 moves inside the tube 124.

In accordance with one or more exemplary embodiments of the present disclosure, the linear actuator 102 may be activated by the user when the user presses the three-way latching switch 108 to close the vehicle closure. Further, if the user holds the three-way latching switch 108 thereby, the linear actuator 102 may be configured to drive the vehicle closure until the vehicle closure closes to the fully closed position. The first hall sensor 118a may be positioned at the first proximal portion 138 of the linear actuator 102 and is configured to detect the fully closed position of the vehicle closure thereby, the first hall sensor 118a functions to deactivate the motor 132 when the vehicle closure closes to the fully closed position.

The quick connect ball sockets 104a and 104b (a first ball socket 104a and a second ball socket 104b) may be positioned at the terminal ends of the tube 124 configured to attach to the vehicle body. One of the ball sockets is over-molded onto a steel end plug. The end plug is hydraulically staked to the nut tube. This allows adjustment to the ball socket angle to match vehicle packaging requirements. One of the ball sockets is over-molded onto a threaded insert. The ball socket assembly is secured to the housing with the screw. This allows adjustment to the ball socket angle to match vehicle packaging requirements. The magnet 112 may be positioned at the outer nut flutes. The first housing 102a and the inner flutes 116 may be configured to allow axial movement of the outer flutes 126 and the tube 124. The screw 116 may be designed with low lead, so the linear actuator is not back-drivable by external forces. The plastic 122 may be designed as the anti-rattle component 130 to eliminate rattle as the low lead screw 120 moves inside the tube 124. The second middle portion 146 of the second housing assembly 102b accommodates a gearbox 134, and the second distal portion 148 of the second housing assembly 102b accommodates a motor 132.

Referring to FIG. 2A is a diagram 200a depicting the first housing of the linear actuator device assembly, in accordance with one or more exemplary embodiments. The diagram 200a depicts the first housing assembly 102a, the second housing assembly 102b, and the inner flutes 116. The inner flutes 116 may be configured to allow translation movement of the nuts 128 and the tube 124.

Referring to FIG. 2B is another diagram 200b depicting the nuts and the tube assembly, in accordance with one or more exemplary embodiments. The diagram 200b depicts outer flutes 126, the magnet 112, the tube 124, and the nuts 128. The outer flutes 126 may be over-molded onto the tube 124 and are configured to allow transition movement of the nuts 128. The outer flutes 126 may slip fit to housing the inner flutes 116. The magnet 112 may be attached to the outer flutes 126.

Referring to FIG. 3A is another diagram 300a depicting an internal relay unit and the hall sensor limit switch, in accordance with one or more exemplary embodiments. The diagram 300a depicts a power distribution unit 302, an internal relay unit 304, the first hall sensor 118a, the second hall sensor 118b, the three-way latching switch 108, and the motor 132. The internal relay unit 304 may be positioned inside a spindle. The spindle may be the power distribution unit 302. The first hall sensor 118a, and the second hall sensor 118b are limit switches configured to control the relay coils. The three-way latching switch 108 may be configured to switch the operating state of the first hall sensor 118a, and the second hall sensor 118b. The operating state of the first hall sensor 118a, and the second hall sensor 118b may include, on state, and off state. For example, a four wire connection is required to establish the electrical connection between the power distribution unit 302 and the three-way latching switch 108.

Referring to FIG. 3B is another diagram 300b depicting an external relay unit and the hall sensor limit switch, in accordance with one or more exemplary embodiments. The diagram 300b depicts the power distribution unit 302, an external relay unit 306, the first hall sensor 118a, the second hall sensor 118b, the three-way latching switch 108, and the motor 132. The external relay unit 306 may be positioned externally to the spindle. The spindle may be the power distribution unit 302. The first hall sensor 118a, and the second hall sensor 118b are limit switches configured to switch the relay coils to the ground. The three-way latching switch 108 may be configured to switch +12v to the relay coil. For example, a six-wire connection is required to establish the electrical connection between the power distribution unit 302, the external relay unit 306, and the three-way latching switch 108.

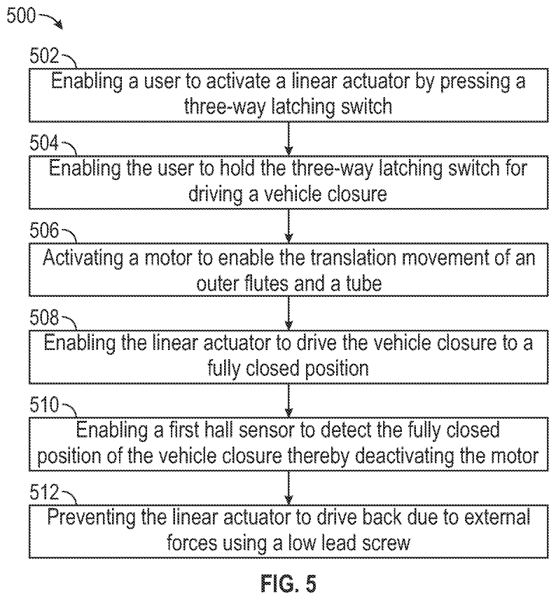

Referring to FIG. 4 is a flow diagram 400 depicting a method for activating the second hall sensor when the tube opens to the fully open position, in accordance with one or more exemplary embodiments. The method 400 may be carried out in the context of the details of FIG. 1A, FIG. 1B, FIG. 2A, FIG. 2B, FIG. 3A, and FIG. 3B. However, the method 400 may also be carried out in any desired environment. Further, the aforementioned definitions may equally apply to the description below.

The method commences at step 402, allowing a user to activate a linear actuator by pressing a three-way latching switch. Thereafter at step 404, allowing the user to hold the three-way latching switch for driving the vehicle closure. Thereafter at step 406, activating the motor to enable the translation movement of the outer flutes and tube. Thereafter at step 408, enabling the linear actuator to drive the vehicle closure to the fully open position. Thereafter at step 410, enabling the second hall sensor detects the fully open position of the vehicle closure thereby deactivating the motor. The second hall sensor may be positioned at the first distal portion of the linear actuator. Thereafter at step 412, preventing the linear actuator from driving back due to external forces using the low lead screw.

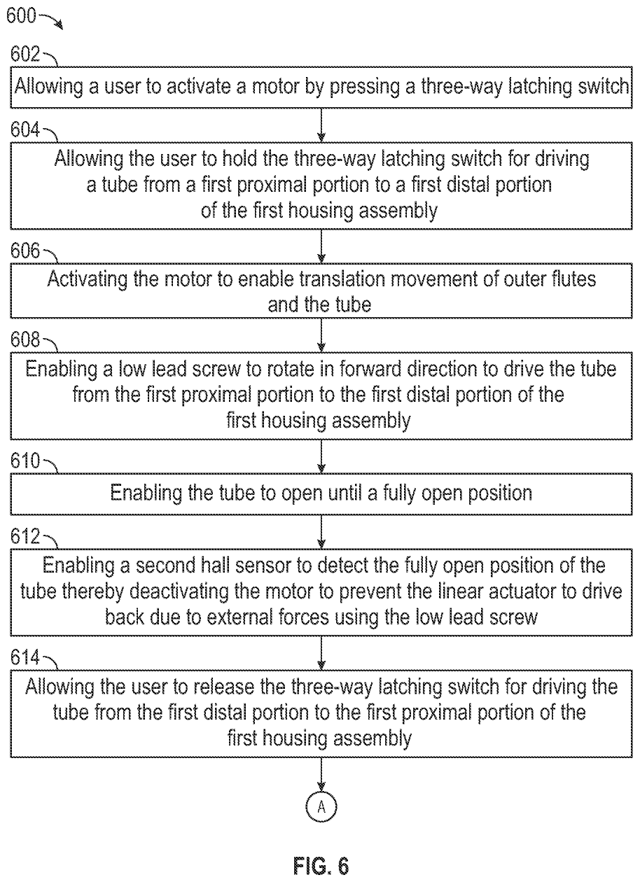

Referring to FIG. 5 is a flow diagram 500 depicting a method for activating the first hall sensor when the tube closes to the fully closed position, in accordance with one or more exemplary embodiments. The method 500 may be carried out in the context of the details of FIG. 1A, FIG. 1B, FIG. 2A, FIG. 2B, FIG. 3A, FIG. 3B and FIG. 4. However, the method 500 may also be carried out in any desired environment. Further, the aforementioned definitions may equally apply to the description below.

The method commences at step 502, enabling the user to activate the linear actuator by pressing the three-way latching switch. Thereafter at step 504, enabling the user to hold the three-way latching switch for driving the vehicle closure. Thereafter at step 506, activating the motor to enable the translation movement of the outer flutes and tube. Thereafter at step 508, enabling the linear actuator to drive the vehicle closure to the fully closed position. Thereafter at step 510, enabling the first hall sensor to detect the fully closed position of the vehicle closure thereby deactivating the motor. The first hall sensor may be positioned at the first proximal portion of the linear actuator. Thereafter at step 512, preventing the linear actuator from driving back due to external forces using the screw with low lead.

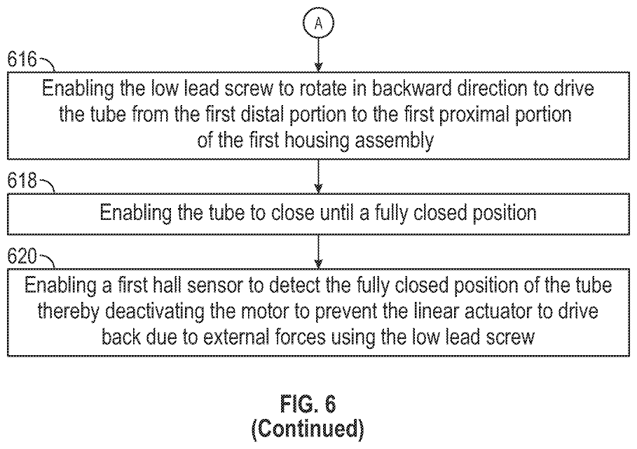

Referring to FIG. 6 is a flow diagram 600 depicting a method for opening and closing the tube using the non-back drivable linear actuator, in accordance with one or more exemplary embodiments. The method 600 may be carried out in the context of the details of FIG. 1A, FIG. 1B, FIG. 2A, FIG. 2B, FIG. 3A, FIG. 3B, FIG. 4, and FIG. 5. However, the method 600 may also be carried out in any desired environment. Further, the aforementioned definitions may equally apply to the description below.

The method commences at step 602, allowing the user to activate the motor by pressing the three-way latching switch. Thereafter at step 604, allowing the user to hold the three-way latching switch for driving the tube from the first proximal portion to the first distal portion of the first housing assembly. Thereafter at step 606, activating the motor to enable translation movement of the outer flutes and the tube. Thereafter at step 608, enabling the low lead screw to rotate in the forward direction to drive the tube from the first proximal portion to the first distal portion of the first housing assembly. Thereafter at step 610, enabling the tube to open until the fully open position. Thereafter at step 612, enabling the second hall sensor to detect the fully open position of the tube thereby deactivating the motor to prevent the linear actuator from driving back due to external forces using the low lead screw. Thereafter at step 614, allowing the user to release the three-way latching switch for driving the tube from the first distal portion to the first proximal portion of the first housing assembly. Thereafter at step 616, enabling the low lead screw to rotate in a backward direction to drive the tube from the first distal portion to the first proximal portion of the first housing assembly. Thereafter at step 618, enabling the tube to close until the fully closed position. Thereafter at step 620, enabling the first hall sensor to detect the fully closed position of the tube, thereby deactivating the motor to prevent the linear actuator from driving back due to external forces using the low lead screw.

In an exemplary embodiment of the present disclosure, a non-back drivable linear actuator system, includes a first housing assembly 102a and a second housing assembly 102b, the first housing assembly 102a includes a first proximal portion 138, a first middle portion 140 and a first distal portion 142, the first proximal portion 138 of the first housing assembly 102a accommodate nuts 128 configured with inner flutes 116 and a first hall sensor 118a; the first middle portion 140 of the first housing assembly 102a accommodate a tube 124, a low lead screw 120 and an anti-rattle component 130, the low lead screw 120 and the anti-rattle component 130 located inside the tube 124; the first distal portion 142 of the first housing assembly 102a accommodate a second hall sensor 118b.

In another embodiment of the present disclosure, a first ball socket 104a is connected to the first proximal portion 138 of the first housing assembly 102a; a second ball socket 104b is connected to the first distal portion 142 of the first housing assembly 102a. The second housing assembly 102b includes a second proximal portion 144, a second middle portion 146 and a second distal portion 148, the second proximal portion 144 of the second housing assembly 102b accommodates gears 136; the second middle portion 146 of the second housing assembly 102b accommodates a gearbox 134; and the second distal portion 148 of the second housing assembly 102b accommodates a motor 132.

In another embodiment of the present disclosure, the system includes a three-way latching switch 108 is configured to activate the motor 132 to enable translation movement of the inner flutes 116 and the tube 124 upon pressing the three-way latching switch 108 by a user. The low lead screw 120 is configured to perform translation movement of the one or more inner flutes 116 and the tube 124. The inner flutes 116 are configured to allow translation movement of the nuts 128. The nuts 128 are over molded onto the tube 124. The tube 124 includes outer flutes that are configured to allow translation movement of the nuts 128. The outer flutes includes a magnet fixed to the nuts 128. The low lead screw 120 is configured to drive the tube 124 from at least one of: the first proximal portion 138 to the first distal portion 142 of the first housing assembly 102a; or the first distal portion 142 to the first proximal portion 138 of the first housing assembly 102a; when the user holds the three-way latching switch 108.

In another embodiment of the present disclosure, the motor 132 is configured to rotate the low lead screw 120 in the forward direction to drive the tube 124 from the first proximal portion 138 to the first distal portion 142 of the first housing assembly 102a to open the vehicle closure. The motor 132 is configured to rotate the low lead screw 120 in a backward direction to drive the tube 124 from the first distal portion 142 to the first proximal portion 138 of the first housing assembly 102a to close the vehicle closure. The first hall sensor 118a is configured to detect the fully closed position of the tube 124 when the low lead screw 120 drives the tube 124 from the first distal portion 142 to the first proximal portion 138 of the first housing assembly 102a. The second hall sensor 118b is configured to detect the fully open position of the tube 124 when the low lead screw 120 drives the tube 124 from the first proximal portion 138 to the first distal portion 142 of the first housing assembly 102a.

In another embodiment of the present disclosure, the first hall sensor 118a and the second hall sensor 118b are potted or sealed with a gasket for water protection. The first hall sensor 118a is positioned at a fully closed position of the non-back drivable linear actuator system. The second hall sensor is positioned at the fully opened position of the non-back drivable linear actuator system. The anti-rattle component 130 is designed with spring features to eliminate rattle as the low lead screw 120 moves inside the tube 124. The system includes relay components housed inside the linear actuator are controlled by limit switches. The relay components include an internal relay unit 304 and an external relay unit 306 are housed in a vehicle near the three-way latching switch 108 controlled by the user.

In another embodiment of the present disclosure, a method for opening and closing a tube 124 using a non-back drivable linear actuator, includes allowing a user to activate a motor 132 by pressing a three-way latching switch 108; allowing the user to hold the three-way latching switch 108 for driving a tube 124 from a first proximal portion 138 to a first distal portion 142 of the first housing assembly 102a; activating the motor 132 to enable translation movement of one or more outer flutes and the tube 124; enabling a low lead screw 120 to rotate in forward direction to drive the tube 124 from the first proximal portion 138 to the first distal portion 142 of the first housing assembly 102a; enabling the tube 124 to open until a fully open position; enabling a second hall sensor 118b to detect the fully open position of the tube 124 thereby deactivating the motor 132 to prevent the linear actuator to drive back due to external forces using the low lead screw 120; allowing the user to release the three-way latching switch 108 for driving the tube 124 from the first distal portion 142 to the first proximal portion 138 of the first housing assembly 102a; enabling the low lead screw 120 to rotate in backward direction to drive the tube 124 from the first distal portion 142 to the first proximal portion 138 of the first housing assembly 102a; enabling the tube 124 to close until a fully closed position; and enabling a 118a to detect the fully closed position of the tube 124 thereby deactivating the motor 132 to prevent the linear actuator to drive back due to external forces using the low lead screw 120.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A non-back drivable linear actuator system, comprising:
a first housing assembly and a second housing assembly, whereby the first housing assembly comprises a first proximal portion, a first middle portion and a first distal portion, whereby the first proximal portion of the first housing assembly accommodates one or more nuts configured with one or more inner flutes and a first hall sensor; the first middle portion of the first housing assembly accommodate a tube, a low lead screw, and an anti-rattle component, wherein the low lead screw and the anti-rattle component located inside the tube; the first distal portion of the first housing assembly accommodate a second hall sensor;
a first ball socket connected to the first proximal portion of the first housing assembly; a second ball socket connected to the first distal portion of the first housing assembly; and
the second housing assembly comprises a second proximal portion, a second middle portion, and a second distal portion, whereby the second proximal portion of the second housing assembly accommodates gears, the second middle portion of the second housing assembly accommodates a gearbox; and the second distal portion of the second housing assembly accommodates a motor.

2. The system of claim 1, further comprising a three-way latching switch is configured to activate the motor to enable translation movement of the one or more inner flutes and the tube upon pressing the three-way latching switch by a user.

3. The system of claim 2, wherein the low lead screw is configured to perform translation movement of the one or more inner flutes and the tube.

4. The system of claim 2, wherein the one or more inner flutes are configured to allow translation movement of the one or more nuts.

5. The system of claim 4, wherein the one or more nuts are over molded onto the tube.

6. The system of claim 1, wherein the tube comprising one or more outer flutes are configured to allow translation movement of the one or more nuts.

7. The system of claim 6, wherein the one or more outer flutes comprise a magnet fixed to the one or more nuts.

8. The system of claim 1, wherein the low lead screw is configured to drive the tube from at least one of: the first proximal portion to the first distal portion of the first housing assembly; or the first distal portion to the first proximal portion of the first housing assembly; when the user holds the three-way latching switch.

9. The system of claim 1, wherein the motor is configured to rotate the low lead screw in a forward direction to drive the tube from the first proximal portion to the first distal portion of the first housing assembly to open the vehicle closure.

10. The system of claim 1, wherein the motor is configured to rotate the low lead screw in a backward direction to drive the tube from the first distal portion to the first proximal portion of the first housing assembly to close the vehicle closure.

11. The system of claim 1, wherein the first hall sensor is configured to detect the fully closed position of the tube when the low lead screw drives the tube from the first distal portion to the first proximal portion of the first housing assembly.

12. The system of claim 1, wherein the second hall sensor is configured to detect the fully open position of the tube when the low lead screw drives the tube from the first proximal portion to the first distal portion of the first housing assembly.

13. The system of claim 1, wherein the first hall sensor and the second hall sensor are potted or sealed with a gasket for water protection.

14. The system of claim 1, wherein the first hall sensor is positioned at a fully closed position of the non-back drivable linear actuator system.

15. The system of claim 1, wherein the second hall sensor is positioned at the fully opened position of the non-back drivable linear actuator system.

16. The system of claim 1, wherein the anti-rattle component is designed with a spring features to eliminate rattle as the low lead screw moves inside the tube.

17. The system of claim 1, further comprises one or more relay components housed inside the linear actuator.

18. The system of claim 1, further comprising the one or more relay components are housed in a vehicle near the three-way latching switch controlled by the user.

19. A method for opening and closing a tube using a non-back drivable linear actuator, comprising:
allowing a user to activate a motor by pressing a three-way latching switch;
allowing the user to hold the three-way latching switch for driving a tube from a first proximal portion to a first distal portion of the first housing assembly;
activating the motor to enable translation movement of one or more outer flutes and the tube;
enabling a low lead screw to rotate in a forward direction to drive the tube from the first proximal portion to the first distal portion of the first housing assembly;
enabling the tube to open until a fully open position;
enabling a second hall sensor to detect the fully open position of the tube thereby deactivating the motor to prevent the linear actuator from driving back due to external forces using the low lead screw;
allowing the user to release the three-way latching switch for driving the tube from the first distal portion to the first proximal portion of the first housing assembly;
enabling the low lead screw to rotate in a backward direction to drive the tube from the first distal portion to the first proximal portion of the first housing assembly;
enabling the tube to close until a fully closed position; and
enabling a first hall sensor to detect the fully closed position of the tube thereby deactivating the motor to prevent the linear actuator to drive back due to external forces using the low lead screw.
